(19) United States
(12) Patent Application Publication
(10) Pub. No.: US 2004/0247171 A1
(43) Pub. Date: Dec. 9, 2004

(54) Image processing method for appearance inspection

(76) Inventors: Yoshihito Hashimoto, Osaka (JP); Kazutaka Ikeda, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/489,417

(22) PCT Filed: Jul. 24, 2003
(86) PCT No.: PCT/JP03/09373

(30) Foreign Application Priority Data
Jul. 26, 2002 (JP) 2002218999

(51) Int. Cl. G06K 9/00; G06K 9/62

(52) U.S. Cl. 382/141; 382/209

(57) ABSTRACT

A method for appearance inspection utilizes a reference image and an object image. Before determining a final reference image for direct comparison with the object image, the outlines of the reference and object images are extracted and processed in accordance with an error function indicative of linear or quadric deformation of the object image in order to derive error parameters including a position, a rotation angle, and a scale of the object image relative to reference image. The resulting error parameters are applied to transform the reference outline. The step of updating the error parameters and transforming the reference outline is repeated until the updated error parameters satisfy a predetermined criterion with respect to a linear or quadric transformation factor of the object image. Thereafter, the last updated parameters are applied to transform the reference image into the final reference image for direct comparison with the object image.

### TECHNICAL FIELD

The present invention relates to an image processing method for appearance inspection, and more particularly to a method for inspecting an appearance of an object in comparison with a predetermined reference image already prepared as a reference to the object.

### Background Art

Japanese Patent Publication No. 2001-175865 discloses an image processing method for appearance inspection in which an object image is examined in comparison with a reference image to obtain error parameters, i.e., position, rotating angle, and a scale of the object image relative to the reference image. Thus obtained error parameters are then applied to transform the reference image in match with the object image, in order to obtain an area not common to the images. Finally, based upon the value of thus obtained area, it is determined whether or not the object has a defect in appearance such as a flaw, crack, stain or the like.

However, the above scheme of inspecting the object's appearance relying upon the amount of the differentiated area is difficult to compensate for or remove the influence of a possible distortion such as a linear transformation resulting from a relative movement of the object to a camera or a quadric transformation resulting from a deviation of the object from an optical axis of the camera. With this result, the object might be recognized defective although it is actually not.

### DISCLOSURE OF THE INVENTION

In view of the above concern, the present invention has been achieved to provide a unique method for appearance inspection which is capable of reliably inspecting an object's appearance in well compensation for a possible liner or quadric deformation, and yet with a reduced computing requirement. According to the image processing method of the present invention, a picture of an object is taken to provide an object image for comparison with a predetermined reference image. Then, the object image is processed for extracting an outline thereof to provide an object outline, in addition to the reference image being processed into a reference outline. Then, it is made to process data of the object outline and the reference outline in accordance with a least-square error function indicative of a linear or quadric transformation factor of the object image, in order to derive error parameters including a position, a rotation angle, and a scale of the object outline relative to the reference outline. Then, the resulting error parameters are applied to transform the reference outline. The above step of updating the error parameters and transforming the reference outline is repeated until the updated error parameters satisfy a predetermined criterion with respect to a linear or quadric transformation factor of the object image. Thereafter, the last updated parameters are applied to transform the reference image into a final reference image. Subsequently, the object image is compared with the final reference image in order to select pixels of the object image each having a grey-scale intensity far from a corresponding pixel of the final reference image by a predetermined value or more. Finally, it is made to analyze thus selected pixels to judge whether the object image is different from the reference image, and to provide a defect signal if the object image is different from the reference image. In this manner, the reference image can be transformed into the final reference image for exact and easy comparison with the object image through a loop of transforming only the reference outline in terms of the updating error parameters. Thus, the transformation into the final reference image can be easily realized with a reduced computing requirement as compared to a case in which the reference image itself is transformed successively. With this result, it is possible to compensate for the liner or quadric transformation factor only with a reduced computing capacity, thereby assuring reliable appearance inspection at a reduced hardware requirement.

In a preferred embodiment, a preprocessing is made to prepare the reference image from a standard reference image already prepared for indicating a non-defective object. The picture of the object is examined to determine a frame in which the object appears in rough coincidence with the standard reference image. Then, the object in the frame is compared with the standard reference image to obtain preliminary error parameters including the position, the rotating angle and the scale of the object relative to the standard reference image. Then, the preliminary error parameters are applied to transform the standard reference image into the reference image. As the above preprocessing is free from taking into account the linear or quadric transformation factor, the reference image can be readily prepared for the subsequent processing of the data in accordance with the least square error function.

It is preferred that each of the object outline and the reference outline is obtained by using the Sobel filter to pick up an edge that follows the pixels having local maximum intensity and having a direction (θ) −45° to +45°, wherein the direction (θ) is expressed by θ=tan⁻¹(R/S), where R is a first derivative of the pixel in x-direction and S is a second derivative of the pixel in y-direction of the image. This is advantageous to eliminate irrelevant lines which might be otherwise recognized to form the outline, thereby improving inspection reliability.

Further, each of the object outline and the reference outline may be obtained through the steps of smoothing each of the object image and the reference image to different degrees in order to give a first smoothed image and a second smoothed image, differentiating the first and second smoothed images to give an array of pixels of different numerical signs, and picking up the pixels each being indicated by one of the numerical signs and at the same time being adjacent to at least one pixel of the other numerical sign, and tracing thus picked up pixels to define the outline.

The method may further include the steps of smoothing the picture to different degrees to provide a first picture and a second picture, differentiating the first and second picture to give an array of pixels of different numerical signs, and picking up the pixels of the same signs to provide an inspection zone only defined by thus picked-up pixels. The object image is compared with the final reference image only at the inspection zone to select pixels within the inspection zone each having a grey-scale intensity far from a corresponding pixel of the final reference image by the predetermined value or more. This is advantageous to eliminate background noises in determination of the defect.

In the present invention, the analysis of the pixels is preferably carried out with reference to a coupling area in which the selected pixels are arranged in an adjacent relation to each other. After determining the coupling area, it is made to calculate a pixel intensity distribution within the coupling area, and to examining geometries of the coupling area. Then, the coupling area is classified as one of predetermined kinds of defects according to the pixel intensity distribution and the geometry so that information of thus classified kind is output for confirmation by a human or device for sophisticated control of the object.

These and still other object and advantageous features of the present invention will become more apparent from the following description of a preferred embodiment when taken in conjunction with the attached drawings.

### BRIEF DESCRIPTION OF THE DRAWINGS

FIG. 1 is a block diagram illustrating a system realizing an image processing method for appearance inspection in accordance with a preferred embodiment of the present invention;

FIG. 2 is a flow chart illustrating steps of the above processing method;

FIG. 3 illustrates how an object image is compared with a reference image according the above method;

FIG. 4A illustrates the object image in a normal appearance;

FIGS. 4B and 4C illustrate possible object images in linear transformation appearance;

FIGS. 5A and 5B illustrate possible object images in quadric transformation appearance;

FIG. 6 is a view illustrating a scheme of executing an error function for evaluation of the object image with reference to the reference image;

FIG. 7 illustrates an coupling area utilized for analysis of the object image;

FIG. 8 illustrates a sample reference image for explanation of various possible defects defined in the present invention;

FIGS. 9A to 9D are object images having individual defects; and

FIGS. 10A to 10D illustrate the kinds of the defects determined respectively for the object images of FIGS. 9A to 9D.

### BEST MODE FOR CARRYING OUT THE INVENTION

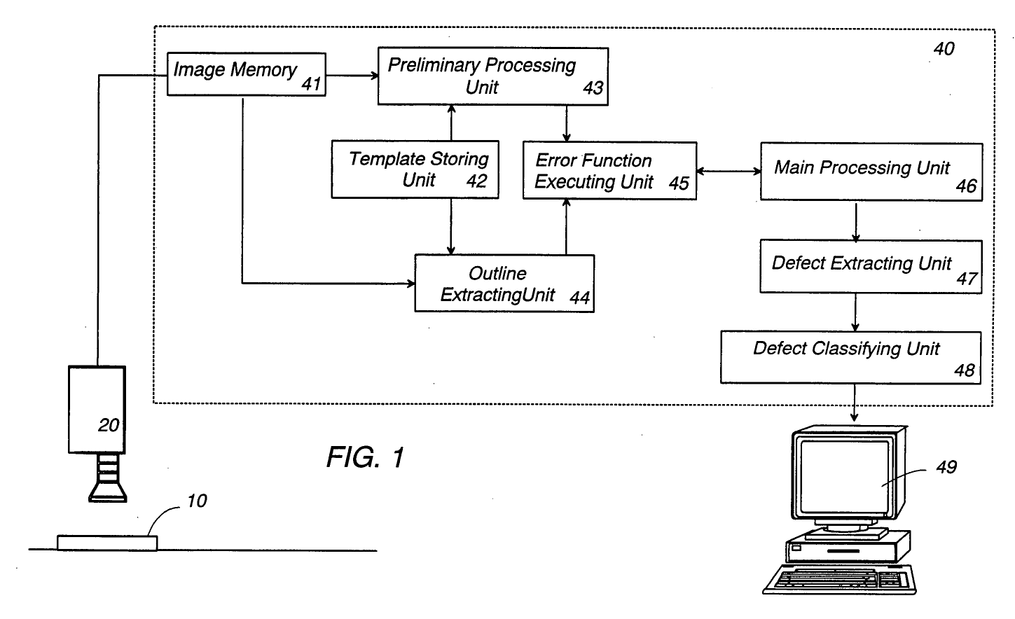

Referring now to FIG. 1, there is shown a system realizing the image processing method for appearance inspection in accordance with a preferred embodiment of the present invention. The system includes a camera 20 and a micro-computer 40 giving various processing units. The camera 20 takes a picture of an object 10 to be inspected and outputs a gray-scale image composed of pixels each having grey-scale intensity digital values and stored in an image memory 41 of the computer. The computer includes a template storing unit 42 storing a standard reference image taken for an original and defect-free object for comparison with an object image extracted from the picture taken by the camera 20.

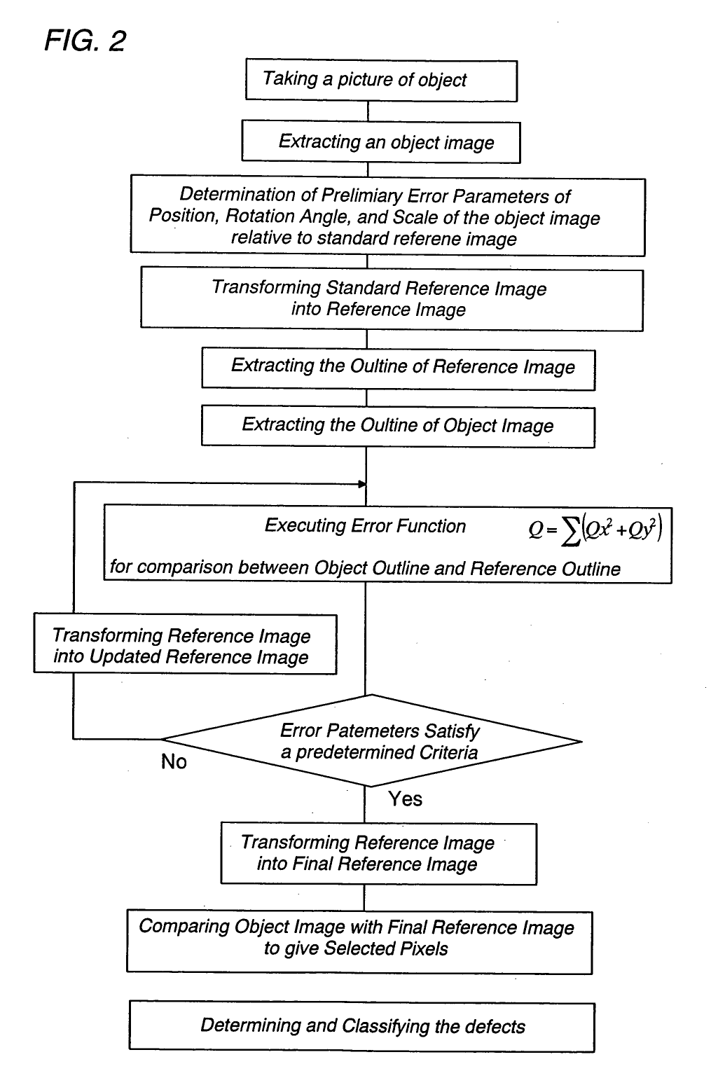

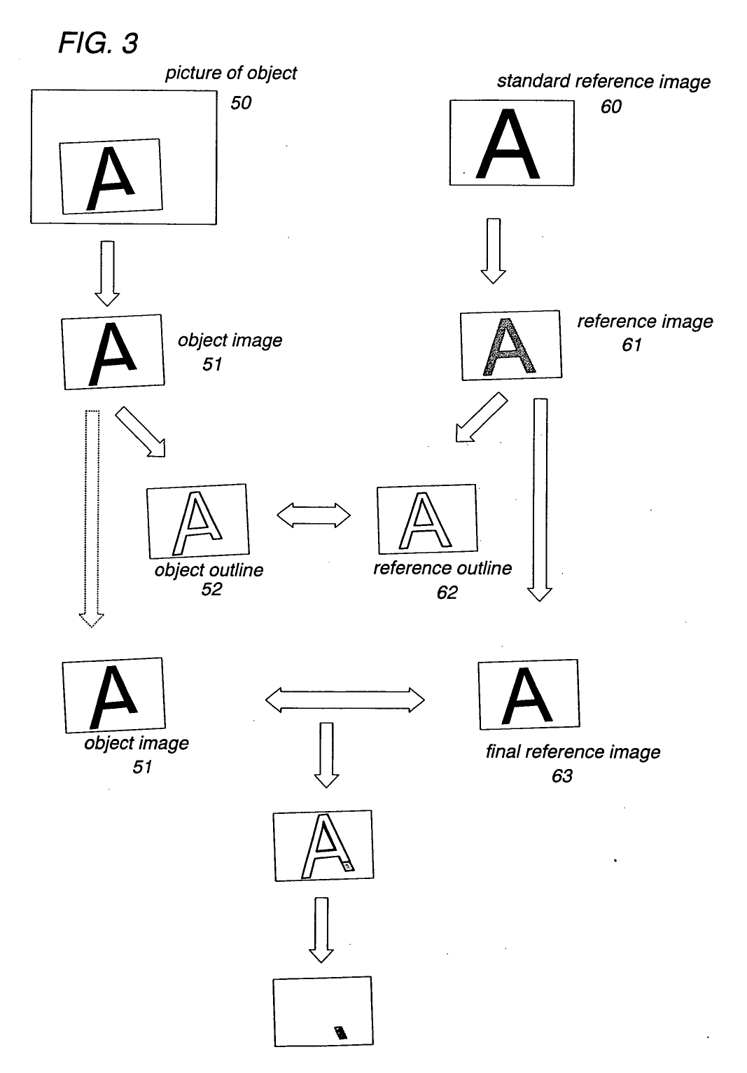

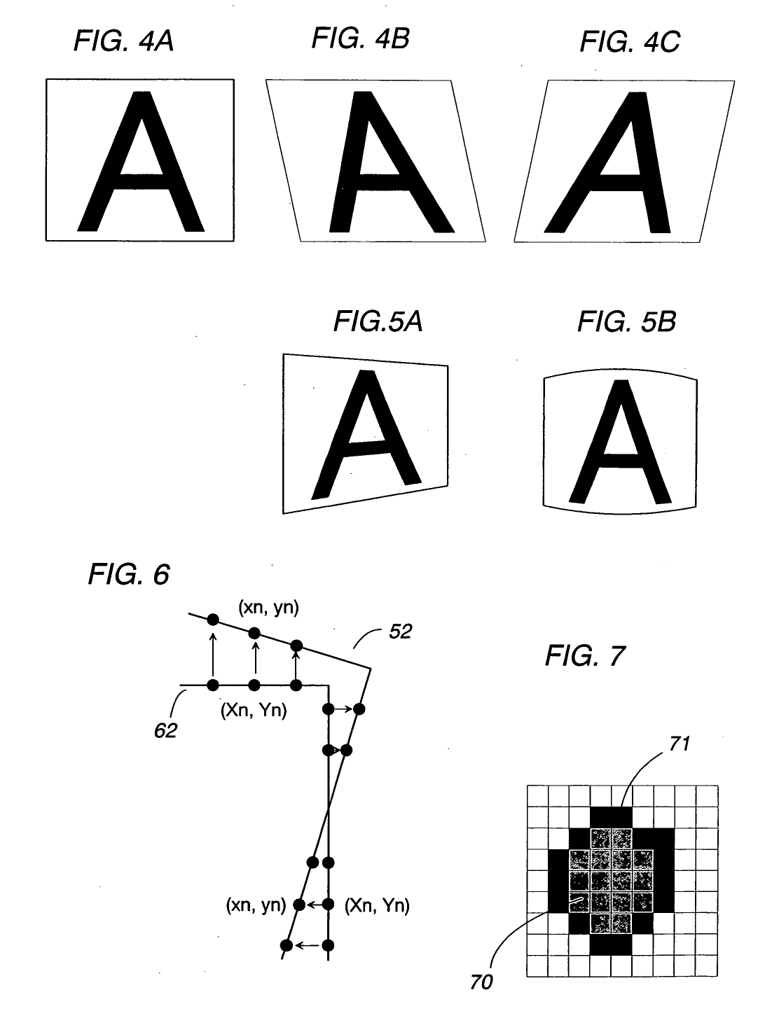

Prior to discussing the details of the system, a brief explanation as to the method of inspecting the object's appearance is made here with reference to FIGS. 2 and 3. After taking the picture of the object, the object image 51 is extracted from the picture 50 with use of the standard reference image 60 to determine preliminary error parameters of a position, a rotating angle, and a scale of the object image relative to the standard reference image 60. Based upon thus determined preliminary error parameters, the standard reference image 60 is transformed into a reference image 61 in rough coincidence with the object image 51. Then, it is made to extract outlines from the object image 51 and also from the reference image 61 for providing an object outline 52 and a reference outline 62, respectively. These outlines 52 and 62 are utilized to obtain a final reference image 63 which takes into account the possible linear deformation or the quadric deformation of the image, and which is compared with the object image for reliably detecting true defects only. That is, the reference outline 62 is transformed repeatedly until certain criterion is satisfied to eliminate the influence of the linear or quadric deformation of the image. For instance, the linear deformation of the object image is seen in FIGS. 4B and 4C as a result of relative movement of the object of FIG. 4A to the camera, while the quadric deformation of the object image is seen in FIG. 5A as a result of a deviation of the object from an optical axis of the camera, and in FIG. 5B as a result of a distortion of a camera lens.

After the reference outline 62 is finally determined to satisfy the criteria, the final reference image 63 is prepared using parameters obtained in a process of transforming the reference outline 62. Then, the object image 51 is compared with the final reference image 63 to determine whether or not the object image 51 includes one of the predefined defects. When the defect is identified, a corresponding signal is issued to make a suitable action in addition to that a code or like visual information is output to be displayed on a monitor 49.

For accomplishing the above functions, the system includes a preliminary processing unit 43 which retrieves the standard reference image 60 from the template storing unit 42 and which extracts the object image 51 with the use of the standard reference image in order to transform the standard reference image into the reference image 61 for rough comparison with the object image 51. The transformation is made based upon a conventional technique such as the generalized Hough transformation or normalized correlation which gives preliminary error parameters of the position, the rotating angle, and the scale of the object image 51 relative to the standard reference image 60. The resulting error parameters are applied to transform the standard reference image 60 into the reference image 61.

Thus transformed reference image 61 and the object image 51 are fed to an outline extracting unit 44 which extracts the outline of these images and provides the reference outline 62 and the object outline 52 to an error function executing unit 45. The error function executing unit 45 executes, under a control of a main processing unit 46, a least-square error function indicative of a linear transformation factor of the object outline 52, in order to obtain error parameters including the position, rotating angle, and scale of the object outline 52 relative to the reference outline 62. The error function involves the linear relation between the object outline and the reference outline, and is expressed by

Q=Σ(Qx²+Qy²) where

Qx=αn(Xn−(A·xn+B·yn+C)),

Qy=αn(Yn−(D·xn+E·yn+F)),

Xn, Yn are coordinates of points along the outline of reference outline 62, xn, yn are coordinates of points along the outline of the object outline 52, and an is a weighting factor.

As shown in FIG. 6, each point (xn, yn) is defined to be a point on the object outline 52 crossed with a line normal to a corresponding point (Xn, Yn) on the reference outline 62.

Parameters A to F denote the position, rotating angle, and the scale of the object outline relative to the reference outline in terms of the following relations.

A=β cos θ

B=−γ sin φ

C=dx

D=β sin θ

E=γ cos φ

F=dy

β=scale (%) in x-direction

γ=scale (%) in y-direction

θ=rotation angle (°) of x-axis

Φ=rotation angle (°) of y-axis

dx=movement in x-direction

dy=movement in y-direction

These parameters are computed by solving simultaneous equations resulting from conditions that

∂Q/∂A=0,∂Q/∂B=0,∂Q/∂C=0,∂Q/∂D=0,∂Q/∂E=0,and ∂Q/∂F=0.

Based upon thus computed parameters, the reference outline 62 is transformed such that the above error function is again executed to obtain fresh parameters. The execution of the error function with the attendant transformation of the reference outline 62 is repeated in a loop until the updated parameters satisfy a predetermined criteria with respect to a linear transformation factor of the object image. For example, when all or some of the parameters of β, γ, θ, Φ, dx and dy are found to be less than predetermined values, respectively, the loop is ended as a consequence of that the linear transformation factor is taken into account, and the parameters are fetched in order to transform the standard reference image or the reference image into the final reference image 63.

Thus obtained final reference image 63 compensates for possible linear deformation of the object image and is compared with the object image 51 on a pixel-by-pixel basis at a defect extracting unit 47 where it is made to select pixels of the object image 51 each having a grey-scale intensity far from a corresponding pixel of the final reference image 63 by a predetermined value or more. The selected pixels can remove the influence of the possible linear deformation of the object image and be well indicative of defects in the object appearance. The selected pixels are examined at a defect classifying unit 48 which analyzes the selected pixels to determine whether or not the object image includes the defect and classify the defect as one of predetermined kinds. If the defect is identified, a defect signal is issued from the defect classifying unit 48 for use in rejecting the object or at least identifying it as defective. At the same time, a code indicative of the kind of the defect is output to the display 49 for visual confirmation.

Explanation will be made hereinafter for classifying the defect as one of the predetermined kinds which include “flaw”, “chip”, “fade”, and “thin” for a foreground, and “background noise”, “fat”, “overplus”, “blur”, and “thick” for a background of the object image. First, it is made to pick up the selected pixels which are adjacent to each other, and define a coupling area 70. Then, as shown in FIG. 7, the coupling area 70 is processed to extract an outline 71. The scheme of identifying the defect is made different depending upon which one of the foreground and background is examined.

When examining the foreground, the following four (4) steps are made for classifying the defect defined by the coupling area 70.

(1) Examining whether or not the extracted outline 71 includes a portion of the outline of the final reference image 63, and providing a flag ‘Yes’ when the extracted outline so includes, and otherwise providing ‘No’.

(2) Examining whether or not the included portion of the outline of the reference image 63 is separated into two or more segments, and providing the flag ‘Yes’ when the outline of the reference image is so separated.

3) Computing a pixel value intensity distribution (dispersion) within the coupling area 70 and checking whether the dispersion is within a predetermined range to see if the coupling area exhibits grey-scale gradation, and providing the flag ‘Yes’ when the dispersion is within the predetermined range.

4) Computing a length of the outline of the coupling area 70 overlapped with the corresponding outline of the final reference image 63 to determine a ratio of the length of thus overlapped outline to the entire length of the outline of the coupling area, and checking whether the ratio is within a predetermined range to provide a flag ‘Yes’ when the ratio is within the range.

The results are evaluated to identify the kind of the defect for the coupling area, according to a rule listed in Table 1 below.

TABLE 1

| | |
|---|---|
| Kinds of | Steps |

| defects | (1) | (2) | (3) | (4) |
|---|---|---|---|---|
| Flaw | No | — | — | — |
| Chip | Yes | Yes | No | — |
| | Yes | | No | Yes |
| Fade | Yes | Yes | Yes | — |
| | Yes | — | Yes | Yes |

| | |
|---|---|
| Thin | Any other combination |

(—) either of Yes/No

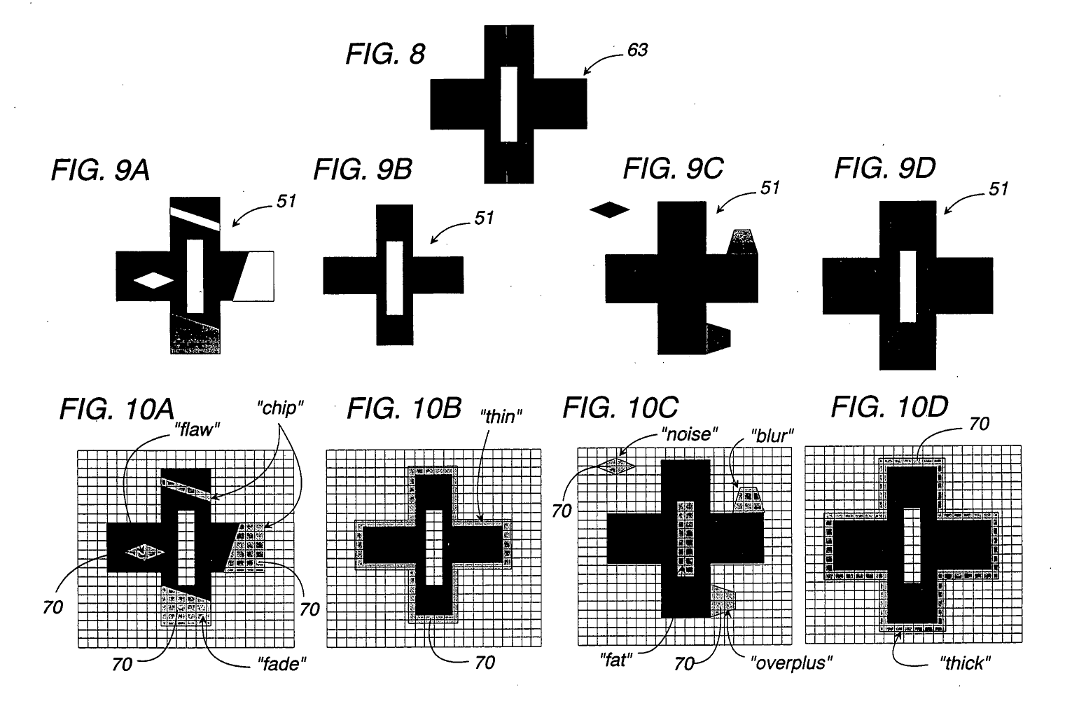

FIGS. 9A and 9B illustrate, for an exemplarily purpose, the above four (4) kinds of the defects that are acknowledged in various possible object images by using the final reference image 63 of FIG. 8. The final reference object image 63 is characterized to have a thick cross with an elongated blank in a vertical segment of the cross.

For the object image of FIG. 9A having various defects in its foreground, the coupling areas 70 are extracted as indicated in FIG. 10A as a result of comparison between the object image 51 and the final reference image 63. Each coupling area 70 is examined in accordance with the above steps, so as to classify the defects respectively as “flaw”, “chip”, and “fade”, as indicated in the figure.

For the object image of FIG. 9B with the cross being thinned, the coupling area 70 surrounding the cross is selected, as shown in FIG. 10B, to be examined in accordance with the above steps, and is classified as “thin”.

When, on the other hand, examining the background of the object image 51, the following five (5) steps are made for classifying the defect defined by the coupling area 70.

1) Examining whether or not the extracted outline 71 includes a portion of the outline of the final reference image, and providing a flag ‘Yes’ when the extracted outline so includes, and otherwise providing ‘No’.

2) Examining whether or not the portion of the outline of the reference image is separated into two or more segments, and providing a flag ‘Yes’ when the included outline of the reference image is so separated.

3) Computing a length of the outline of the final reference image 63 that is included in the coupling area 70 to determine a ratio of thus computed length to the entire length of the outline of the final reference image 63, and providing the flag ‘Yes’ when the ratio is within a predetermined range.

4) Computing a pixel value intensity distribution (dispersion) within the coupling area 70 and checking whether the dispersion is within a predetermined range to see if the coupling area exhibits grey-scale gradation, and providing the flag ‘Yes’ when the dispersion is within the predetermined range.

5) Computing a length of the outline of the coupling area 70 overlapped with the corresponding outline of the final reference image 63 to determine a ratio of the length of thus overlapped outline to the entire length of the outline of the coupling area, and checking whether the ratio is within a predetermined range to provide a flag ‘Yes’ when the ratio is within the range.

The results are evaluated to identify the kind of the defect for the coupling area in the background, according to a rule listed in Table 2 below.

TABLE 2

| Kinds of | Steps | | | | |
|---|---|---|---|---|---|
| defects | (1) | (2) | (3) | (4) | (5) |
| Noise | No | — | — | — | — |
| Fat | Yes | Yes | — | — | — |
| Overplus | Yes | No | Yes | No | — |
| | Yes | No | — | No | Yes |
| Blur | Yes | No | Yes | Yes | — |
| | Yes | No | — | Yes | Yes |

| | |
|---|---|
| Thick | Any other combination |

(—) either of Yes/No

FIGS. 9C and 9D illustrate the above five (5) kinds of the defects acknowledged in various possible object images by using the final reference image of FIG. 8. For the object image of FIG. 9C having various defects in its background, the coupling areas 70 are extracted, as indicated in FIG. 10C, as a result of comparison between the object image 51 and the final reference image 63, and is then examined in accordance with the above steps, so as to classify the defects respectively as “noise”, “fat”, “overplus”, and “fade”, as indicated in the figure.

For the object image of FIG. 9D with the cross being thickened, the coupling area 70 surrounding the cross is selected, as shown in FIG. 10B, and is examined in accordance with the above steps and is classified as “thick”.

Instead of using the above error function, it is equally possible to use another error function, as expressed in the below, that represents the quadric deformation possibly seen in the object image, as explained before with reference to FIGS. 5A and 5B.

Q=Σ(Qx²+Qy²) where

Qx=αn(Xn−(A·xn²+B·xn·yn+C·yn²+D·xn+E·yn+F)),

Qy=αn(Yn−(G·xn²+H·xn·yn+I·yn²+J·xn+K·yn+L))

Xn, Yn are coordinates of points along the outline of reference outline 62, xn, yn are coordinates of points along the outline of the object outline 52, and αn is a weighting factor.

As shown in FIG. 6, each point (xn, yn) is defined to be a point on the object outline 52 crossed with a line normal to a corresponding point (Xn, Yn) on the reference outline 62.

Parameters A to F denote the position, rotating angle, and the scale of the object outline relative to the reference outline in terms of the following relations.

D=β cos θ

E=−γ sin φ

F=dx

J=β sin θ

K=γ cos φ

L=dy

β=scale (%) in x-direction

γ=scale (%) in y-direction

θ=rotation angle (°) of x-axis

Φ=rotation angle (°) of y-axis

dx=movement in x-direction

dy=movement in y-direction

These parameters are computed by solving simultaneous equations resulting from conditions that ∂Q/∂A=0, ∂Q/∂B=0, ∂Q/∂C=0, ∂Q/∂D=0, ∂Q/∂E=0, ∂Q/∂F=0, ∂Q/∂G=0, ∂Q/∂H=0, ∂Q/∂I=0, ∂Q/∂J=0, ∂Q/∂K=0, and ∂Q/∂L=0.

With the use of thus obtained parameters, the reference outline is transformed until the updated parameters satisfy a predetermined criteria indicative of a quadric transformation factor of the object image in a like manner as discussed with reference to the error function indicative of the linear transformation factor.

When extracting the outlines of the object image as well as the reference image by use of the Sobel filter, it is made to trace an edge that follows the pixels having local maximum intensity and having a direction θ of −45° to +45°, wherein the direction (θ) is expressed by a formula

θ=tan⁻¹(R/S), where R is a first derivative of the pixel in x-direction and S is a second derivative of the pixel in y-direction of the image. Thus, the outlines can be extracted correctly.

The present invention should not be limited to the use of the Sobel filter, and could instead utilize another advantageous technique for reliably extracting the outlines with a reduced computing requirement. This technique relies on smoothing of the images and differentiating the smoothed image. First, it is made to smooth each of the object image and the reference image to different degrees in order to give a first smoothed image and a second smoothed image. Then, the smoothed images are differentiated to give an array of pixels of different numeric signs (+/−). Subsequently, it is made to pick up the pixel each being indicated by one of the positive and negative signs and at the same time being adjacent to at least one pixel of the other sign. Finally, the picked up pixels are traced to define the outline for each of the object and reference image. With this result, it is easy to extract the outlines sufficient for determining the final reference image only at a reduced computing load, and therefore at an increased processing speed.

Further, it should be noted that the object image can be successfully extracted from the picture of the object in order to eliminate background noises that are irrelevant to the defect of the object image. The picture 50 is smoothed to different degrees to provide a first picture and a second picture. Then, the first and second pictures are differentiated to give an array of pixels having different numerical signs (+/−) from which the pixels of the same sign are picked up to give an inspection zone only defined by the picked-up pixels. The object image is compared only at the inspection zone with the final reference image to select pixels within the inspection zone each having a grey-scale intensity far from a corresponding pixel of the final reference image by the predetermined value or more. With this technique, it is easy to simplify the computing process for determining the coupling area that is finally analyzed for determination and classification of the defects.

1. An image processing method for appearance inspection, said method comprising the steps of:
a) taking a picture of an object to be inspected to provide an object image for comparison with a reference image;
b) extracting an outline of said object image to give an object outline;
c) extracting an outline of said reference image to give a reference outline;
d) processing data of said object outline and said reference outline in accordance with a least-square error function for deriving error parameters including a position, a rotation angle, and a scale of the object outline relative to said reference outline, and applying the resulting error parameters to transform said reference outline;
e) repeating the step of (d) until said resulting error parameters satisfy a predetermined criterion indicative of a linear transformation factor of said object image;
f) applying said error parameters to transform said reference image into a final reference image;
g) comparing said object image with the final reference image to select pixels of said object image each having a grey-scale intensity far from a corresponding pixel of said final reference image by a predetermined value or more, and
h) analyzing thus selected pixels to judge whether the object image is different from the reference image, and providing a defect signal if the object image is different from the reference image.

2. An image processing method for appearance inspection, said method comprising the steps of:
a) taking a picture of an object to be inspected to provide an object image for comparison with a reference image;
b) extracting an outline of said object image to give an object outline;
c) extracting an outline of said reference image to give a reference outline;
d) processing data of said object outline and said reference outline in accordance with a least-square error function for deriving error parameters including a position, a rotation angle, and a scale of the object outline relative to said reference outline, and applying the resulting error parameters to transform said reference outline;
e) repeating the step of (d) until said resulting error parameters satisfies a predetermined criterion indicative of a quadric transformation factor of said object image;
f) applying said error parameters to transform said reference image into a final reference image;
g) comparing said object image with the final reference image to select pixels of said object image each having a grey-scale intensity far from a corresponding pixel of said final reference image by a predetermined value or more, and
h) analyzing thus selected pixels to judge whether the object image is different from the reference image, and providing a defect signal if the object image is different from the reference image.

3. The method as set forth in claim 1 or 2, wherein
said reference image is obtained through the steps of
using a standard reference image indicating an original object,
examining said picture to determine a frame in which said object appears in rough coincidence with said standard reference image;
comparing the object in said frame with said standard reference image to obtain preliminary error parameters including the position, the rotating angle and the scale of the object in the frame relative to said original reference image,
applying said preliminary error parameters to transform said standard reference image into said reference image.

4. The method as set forth in claim 1 or 2, wherein
each of said object outline and said reference outline is obtained by using the Sobel filter to trace an edge that follows the pixels having local maximum intensity and having a direction θ of −45° to +45°, wherein said direction (θ) is expressed by a formula
θ=tan⁻¹(R/S), where R is a first derivative of the pixel in x-direction and S is a second derivative of the pixel in y-direction of the image.

5. The method as set forth in claim 1 or 2, wherein
each of said object outline and said reference outline is obtained by the steps of:
smoothing each of said object image and said reference image to different degrees in order to give a first smoothed image and a second smoothed image;
differentiating the first and second smoothed images to give an array of pixels of different numerical signs,
picking up the pixels each being indicated by one of numerical signs and at the same time being adjacent to at least one pixel of the other numerical sign, and tracing thus picked up pixels to define the outline.

6. The method as set forth in claim 1 or 2, further comprising steps of:
smoothing the picture to different degrees to provide a first picture and a second picture,
differentiating the first and second picture to give an array of pixels of different numerical signs, and
picking up the pixels of the same signs to provide an inspection zone only defined by thus picked-up pixels,
said object image being compared with said final reference image only at said inspection zone to select pixels within the inspection zone each having a grey-scale intensity far from a corresponding pixel of said final reference image by the predetermined value or more.

7. The method as set forth in claim 1 or 2, wherein
the step (h) of analyzing the pixels comprises the sub-steps of
defining a coupling area in which the selected pixels are arranged in an adjacent relation to each other,
calculating a pixel intensity distribution within said coupling area,
examining geometry of said coupling area,
classifying the coupling area as one of predetermined kinds of defects according to the pixel intensity distribution and the geometry of said coupling area, and outputting the resulting kind of the defect.
